(19) United States
(12) Patent Application Publication
(10) Pub. No.: US 2025/0382123 A1
(43) Pub. Date: Dec. 18, 2025

(54) DEVICES FOR ENCLOSING AND/OR TRANSPORTING BICYLES

(71) Applicant: Vault Sports Box, Columbia Falls, MT (US)

(72) Inventor: Arthur Mayo, Kalispell, MT (US)

(21) Appl. No.: 19/238,202

(22) Filed: Jun. 13, 2025

Related U.S. Application Data
(60) Provisional application No. 63/660,052, filed on Jun. 14, 2024.

(51) Int. Cl. B65D 85/68; B62K 15/00

(52) U.S. Cl. CPC B65D 85/68; B62K 15/00; B62K 2015/001; B65D 2585/6862

(57) ABSTRACT

A carrier for transporting a bicycle can include a bottom enclosure, a frame receiver attached to a back of the bottom enclosure and configured to connect to a bicycle frame at rear dropouts; a fork receiver attached to a bottom surface of the bottom enclosure and configured to connect to front fork dropouts, the fork receiver having a first degree of freedom in movement and rotational movement; a top enclosure; and a plurality of fasteners configured to mechanically secure the top enclosure to the bottom enclosure. When secured together, the bottom and top enclosures can contain the bicycle assembly in an upright orientation with respect to bottom surface. Corresponding methods are also disclosed.

### CROSS-REFERENCE TO RELATED APPLICATIONS

The present application claims the priority and benefit of U.S. Patent Application No. 63/660,052 filed on Jun. 14, 2024, the contents all of which are incorporated by reference herein in their entirety.

### TECHNICAL FIELD

The present disclosure relates generally to container devices and more particularly to devices for transporting bicycles.

### BACKGROUND

Currently, transporting bicycles can include disassembly of bicycle parts, including removing seats, handlebars, front fork, and various controls from a bicycle frame, such as shifting and brake controls. Absent such disassembly, current transportation methods can damage parts of an assembled bicycle in transit.

Consequently, it is not uncommon for bicycle racing teams to include staff dedicated to reassembling, configuring and fine tuning bicycles after they have been delivered to a race location. This can be expensive and time consuming.

It would be desirable to arrive at some way of reducing the cost and manpower involved in transporting bicycles between locations.

### SUMMARY

A carrier for transporting a bicycle can include a bottom enclosure, a frame receiver attached to a back of the bottom enclosure and configured to connect to a bicycle frame at rear dropouts; a fork receiver attached to a bottom surface of the bottom enclosure and configured to connect to front fork dropouts, the fork receiver having a first degree of freedom in movement and rotational movement; a top enclosure; and a plurality of fasteners configured to mechanically secure the top enclosure to the bottom enclosure. When secured together, the bottom and top enclosures can contain the bicycle assembly in an upright orientation with respect to bottom surface. Corresponding methods are also disclosed.

### BRIEF DESCRIPTION OF DRAWINGS

FIG. 1 is a diagram showing a bicycle carrier in a closed configuration according to an embodiment.

FIG. 2 is a diagram showing a top enclosure of a bicycle carrier according to an embodiment.

FIG. 3 is a diagram showing a bottom enclosure of a bicycle carrier according to an embodiment.

FIG. 4 is side cross sectional view of a bottom enclosure of a bicycle carrier showing a bicycle assembly secure therein according to an embodiment.

FIG. 5 is a perspective view of a bottom enclosure of a bicycle carrier showing a bicycle assembly secure therein according to an embodiment.

FIGS. 6-0, 6-1 and 6-2 are diagrams showing a rear frame receiver, according to embodiments. FIG. 6-3 is a diagram showing a bicycle assembly secured to a rear frame receiver according to an embodiment.

FIGS. 7-0, 7-1, 7-2, 7-3, 7-4, 7-5 and 7-6 are diagrams showing a fork receiver according to an embodiment. FIG. 7-7 is a diagram showing a bicycle assembly secured to a fork receiver according to an embodiment.

FIG. 8 is a cross sectional view showing a mating between a top and bottom enclosure according to an embodiment.

FIG. 9 is a diagram showing a fastener that can be included in embodiments.

FIGS. 10-0, 10-1 and 10-2 are diagrams showing carrier wheels that can be included in embodiments.

FIGS. 11-0, 11-1, 11-2, 11-3 and 11-4 are cross sectional and side views of a method for securing and removing a bicycle assembly from a carrier according to an embodiment.

FIGS. 12-0, 12-1, 12-2, 12-3 and 12-4 are diagrams showing a bicycle carrier according to an alternate embodiment.

### DETAILED DESCRIPTION

Embodiments can include a carrier for enclosing a bicycle for transport from one location to another, in which the bicycle can be loaded while substantially assembled and tuned, and thus require little preparation upon arrival at a destination location. A carrier can include wheels attached on the bottom for transporting (e.g., rolling) the carrier.

According to embodiments, a carrier can include a bottom and top enclosure, which can be secured together to enclose a bicycle assembly. A bottom enclosure can include a rear frame receiver and a fork receiver, which can connect to bicycle frame dropouts to secure a bike in an upright position with respect to a bottom surface of the bottom enclosure. Bicycle frame dropouts can include openings for receiving bicycle wheels.

In some embodiments, a rear frame receiver and fork receiver can be the sole sources of securing a bicycle assembly within the carrier. In some embodiments, a bicycle frame can be connected to rear frame and fork receivers by quick release mechanisms.

Embodiments can include methods for securing a bicycle assembly in a protective enclosure, opening the enclosure and removing the bicycle assembly by releasing it from a rear frame dropout receiver and a front fork dropout receiver. In some embodiments, when secured in an enclosure, a bicycle assembly can include handle bars and a crankset attached thereto in operational form. In some embodiments, a seat, brake and shifting systems can also be attached thereto in operational form.

In some embodiments, bicycle wheels can be included in the enclosure that are not attached to the bicycle assembly. In some embodiments, once removed from an enclosure, once wheels are attached to a bicycle assembly, a resulting bicycle may assembled, and need only minor adjustments to be ready to riding or racing.

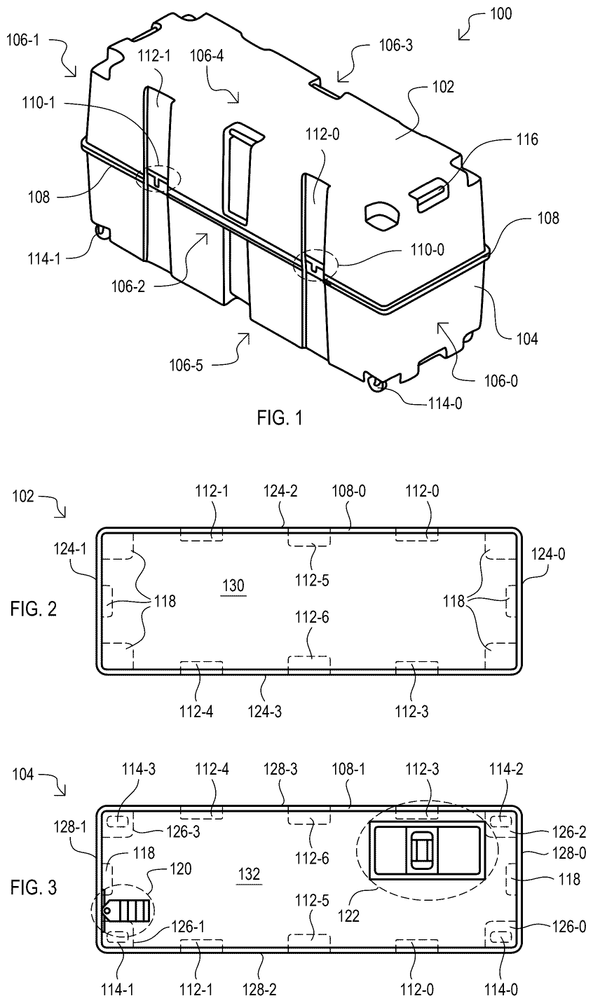

FIG. 1 is a diagram showing a bicycle carrier 100 according to an embodiment. A carrier 100 can include a top enclosure 102, bottom enclosure 104, fasteners 110-0, 110-1, wheels 114-0, 114-1, and handles (one shown as 116). When secured together, a top and bottom enclosure (102, 104) can form a generally rectangular prism shape, having a front side 106-0, a back side 106-1, a first side 106-2, a second side 106-3, a top surface 106-4 and a bottom surface 106-5. A top enclosure 102 can mate with a bottom enclosure 104 at surrounding joining edges 108.

A top enclosure 102 can be secured to a bottom enclosure 104 by one or more fasteners. In the embodiment shown, a bicycle carrier 100 can include two fasteners (110-0, 110-1) set within channels (112-0, 112-1) on first side 106-2 and second side 106-3 (second side fasteners are not visible in FIG. 1). Fasteners (110-0/1) can take any suitable form sufficient to mechanically secure the enclosures 102/104 to one another. In some embodiments, fasteners (110-0/1) can be spring-clips, however this should not be construed as limiting. Once skilled the art could arrive at any alternate or equivalent form of securing enclosures 102/104 together. Channels 112-0/1 can be indentations into a surface of a carrier 100 which can serve as recesses for fasteners 110-0/1.

While embodiments can include carriers having top and bottom enclosures that are separated from one another when removing a bicycle assembly, alternate embodiments can include hinges that can enable a top enclosure to swing open while remaining connected to a bottom enclosure.

A carrier 100 can include wheels 114-0/1 attached to, or proximate a bottom surface to enable a carrier to be rolled on a surface. Wheels 114-0/1 can include axled wheels, casters, powered (e.g., electric) wheels, or any other suitable arrangement that can enable rolling movement.

In some embodiments, a carrier 100 can include handles or attachment for handles (one shown as 116). Handles/attachments can take any suitable form, that can enable a person to pull or push a carrier 100 and/or handle an enclosure 102/104 when separating/opening and/or securing/closing a carrier 100.

FIG. 2 is a diagram of a top enclosure 102 showing a view into an inner surface thereof. FIG. 2 shows items like those of FIG. 1, and such like items are referred to by the same reference characters. A top enclosure 102 can include a top front side 124-0, a top back side 124-1, a top first side 124-2, a top second side 124-3, and a top inside surface 130. A top enclosure 102 can also include channels 112-0, 112-1, 112-2, 112-3, 112-4, 112-5 formed by indentations in top first and top second sides 124-2/3. In the embodiment shown, a top enclosure 102 can also include indentations 118.

FIG. 3 is a diagram showing a view of a bottom enclosure 104 into a bottom surface thereof. FIG. 3 shows items like those of FIG. 1, and such like items are referred to by the same reference characters. A bottom enclosure 104 can include a bottom front side 128-0, a bottom back side 128-1, a bottom first side 128-2, a bottom second side 128-3, and a bottom inside surface 132. A bottom enclosure 104 can also include channels 112-0, 112-1, 112-2, 112-3, 112-4 and 112-5.

In the embodiment shown, a bottom enclosure 104 can also include wheel indentations 126-0, 126-1, 126-2 and 126-3, at which wheel mechanisms 114-0, 114-1, 114-2, 114-3 can be attached.

A bottom enclosure 104 can include a rear frame receiver 120 and a fork receiver 122. A rear frame receiver 120 can be attached to a rear side 128-1 A fork receiver 122 can be attached to a bottom surface 132. A bicycle assembly can be secured in a bottom enclosure by being connected at a rear frame receiver 120 and fork receiver 122. In some embodiments, a rear frame receiver 120 can connect to a bicycle frame at rear dropouts and a fork receiver 122 can connect to front forks dropouts.

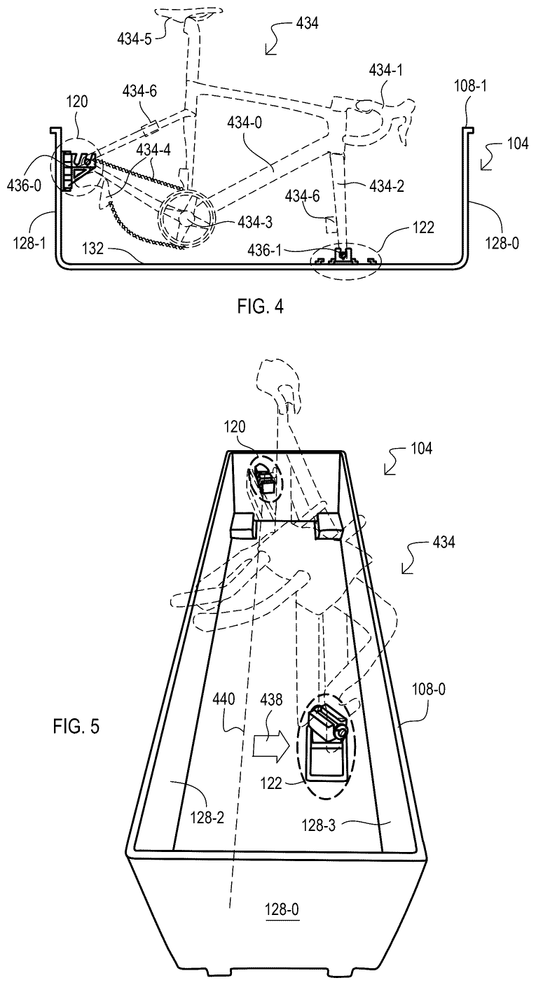

FIG. 4 is a side cross sectional view of a bicycle assembly 434 secured within a bottom enclosure 104 according to an embodiment. Bottom enclosure 104 can be formed with a front side 128-0, rear side 128-1 and bottom surface 132, and can have attached thereto a rear frame receiver 120 and fork receiver 122. A rear frame receiver 120 can be disposed on an inner surface of rear side 128-1, and can connect to a bicycle assembly 434 at rear dropouts 436-0. Rear dropouts 436-0 can provide structures that enable a rear wheel to be connected to a bike assembly 434. A fork receiver 122 can be disposed on an inside of bottom surface 132, and can connect to a bicycle assembly 434 front fork dropouts 436-1. Front fork dropouts 436-1 can provide structures that can enable a front wheel to be connected to a bike assembly 434. Front fork dropouts and rear dropouts 436-0/1 can take any suitable form, including open dropouts and/or closed dropouts.

A bicycle assembly 434, when attached to a bottom enclosure 104, can be substantially assembled, having components in addition to a bicycle frame 434-0 and forks 434-2. In some embodiments, in addition to a frame 434-0 and forks 434-1, a bicycle assembly 434 can include any or all of, a crankset with crankarms 434-3, all or part of a driving system 434-4 (e.g., derailleur, chain, belt, driveshaft, gearbox), a seat 434-5, and/or brake and/or shifting system 434-6. In this way, a bicycle assembly 434 can be transported substantially ready for use, needing little additional assembly upon arrival at a destination.

FIG. 5 is a perspective view showing a bicycle assembly 434 attached to a bottom enclosure 104. FIG. 5 shows items like those of FIG. 4, and such like items are referred to by the same reference characters. FIG. 5 shows how, in some embodiments, a fork receiver 122 can be offset from a frame receiver 120 with respect to a longitudinal direction (a direction from the front to back). FIG. 5 shows an imaginary line 440 extending in a longitudinal direction aligned with a frame receiver 120. A fork receiver 122 can be offset in a direction 438 with respect line 440.

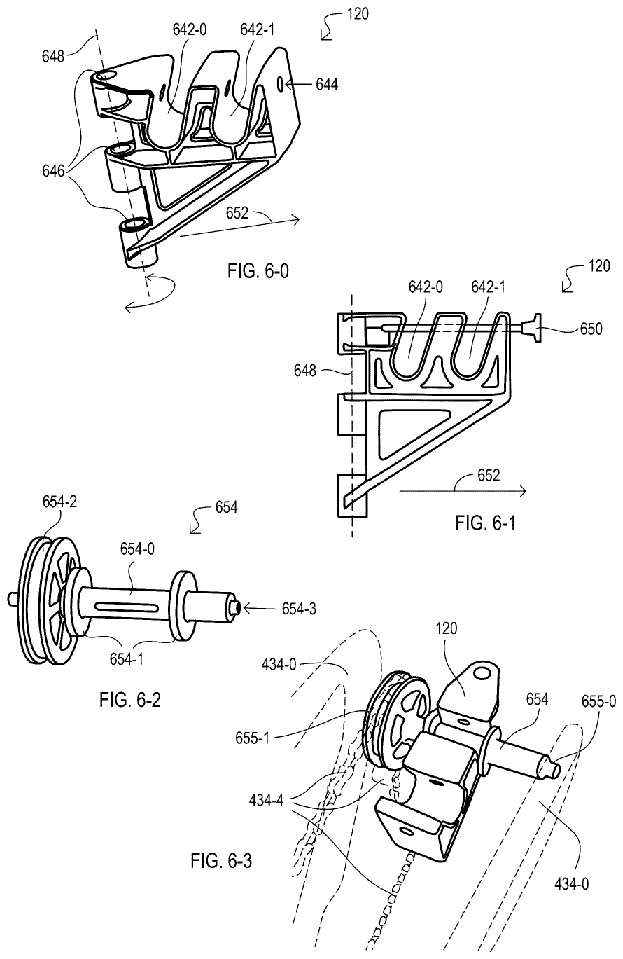

FIGS. 6-0, 6-1 and 6-2 are diagrams of a frame receiver 120 according to an embodiment. FIG. 6-0 is a perspective view, while FIG. 6-1 is a side view. A frame receiver 120 can be a rigid body having one or more openings 642-0, 642-1 that can be displaced from one another in a mounting direction 652. A mounting direction 652 can be a direction away from a point at which frame receiver 120 is mounted, or otherwise fixed to a lower enclosure (not shown). Opening(s) 642-0/1 can take any suitable from for enabling attachment to a bicycle frame. While FIGS. 6-0/1 show two openings 642-0/1, alternate embodiments can include a greater number of openings, and/or one or more openings with adjustable positions (i.e., the ability to be positioned at two or more different distances in the mounting direction 652). As will be described in more detail herein, in some embodiments, a frame receiver 120 can include a replacement rear axle that can be positioned in an opening 642-0/1 that can connect/receive rear dropouts of a bicycle assembly.

Referring still to FIGS. 6-0/1, a frame receiver 120 can further include a securing mechanism for ensuring a bicycle frame remains secured to a frame receiver 120. In the embodiment shown, such a securing mechanism can include secure pin holes 644 that extend through a frame receiver, and a securing pin 650 that can be inserted into secure pin holes 644. However, any other suitable mechanism can be included, including latches, clips, elastic bands, as but a few of many alternatives anticipated by this disclosure.

A frame receiver 120 can provide rotational movement at a secured end to more easily position a bicycle assembly within a bottom enclosure. In some embodiments, such rotational movement can be in a plane generally parallel to a bottom surface of a rear enclosure and/or generally perpendicular to a rear side. In the embodiment shown, a frame receiver 120 can include rotation openings 646 that can receive a cylindrical post (not shown), to provide rotation about a rotation axis 648.

FIG. 6-2 shows a rear axle substitute 654 that can be included in a frame receiver 120. A rear axle substitute 654 can be positioned within any of openings 642-0/1, and receive rear dropouts of a bicycle frame. In the embodiment shown, a rear axle substitute 654 can include a seating portion 654-0, securing members 654-1, drive member receiver 654-2, and securing through hole 654-3. Seating portion 654-0 can be positioned within any of openings 642-0/1. Securing members 654-1 can ensure rear axle substitute 654 remains in position in a lateral direction. In some embodiments, securing members 654-1 can be adjustable in a lateral direction. Drive member receiver 654-2 can receive and/or connect to a driving system of a bicycle assembly. In the embodiment of FIG. 6-2, drive member receiver 654-2 can receive a chain. While drive member receiver 654-2 is shown to have a smooth surface for receiving a chain, alternate embodiments can include grooves, teeth or any other suitable structure for engaging with a chain. A securing through hole 654-3 can extend through a rear axle substitute 654 in a lateral direction. In some embodiments, securing through hole 654-3 can receive a quick release mechanism. In some embodiments, such a quick release mechanism can be the same as that which secures a rear wheel to the transported bicycle frame.

FIG. 6-3 is a perspective view showing a frame receiver 120 with a rear axle substitute 654 positioned in an opening. Also shown is a bike assembly secured to the frame receiver 120, including bike frame 434-0 and driving member 434 (e.g., chain and derailleur). It is understood that rear dropouts can connect to ends of rear axle substitute 654 and distal ends 655-0 and 655-1 of rear axle substitute 654.

FIGS. 7-0 to 7-7 are diagrams showing a fork receiver 122 according to an embodiment. A fork receiver 122 can be attached to a surface of a bottom enclosure, and can connect to a bicycle assembly (e.g., at front fork dropouts). According to embodiments, a fork receiver 122 can provide movement to accommodate bicycle assemblies of different sizes and configurations. In some embodiments, such movement can include any or all of, longitudinal movement (e.g., movement generally toward the front and/or back of the carrier), lateral movement (e.g., movement generally toward a first and/or second side of the carrier), and rotational movement. In some embodiments, such rotational movement can be generally in plane parallel to a surface to which the fork receiver is attached. While FIGS. 7-0 to 7-7 show a particular fork receiver, such an arrangement should not be construed as limiting.

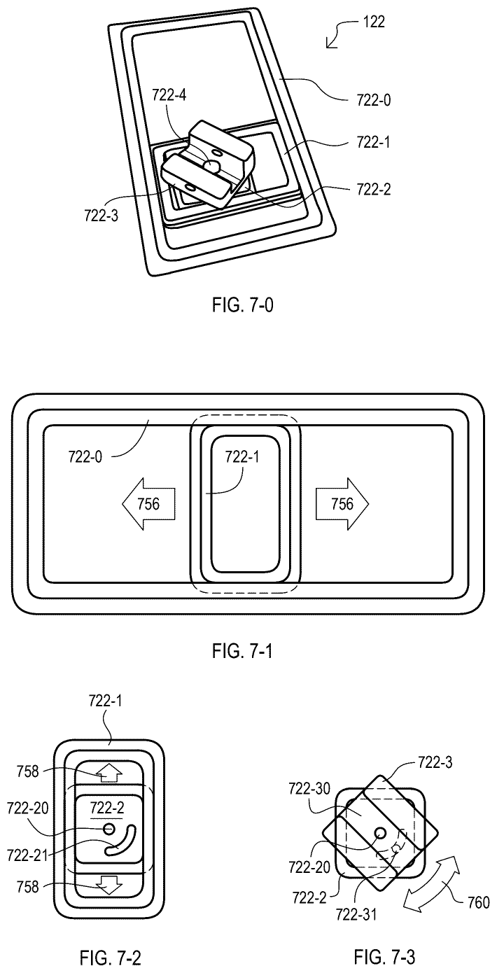

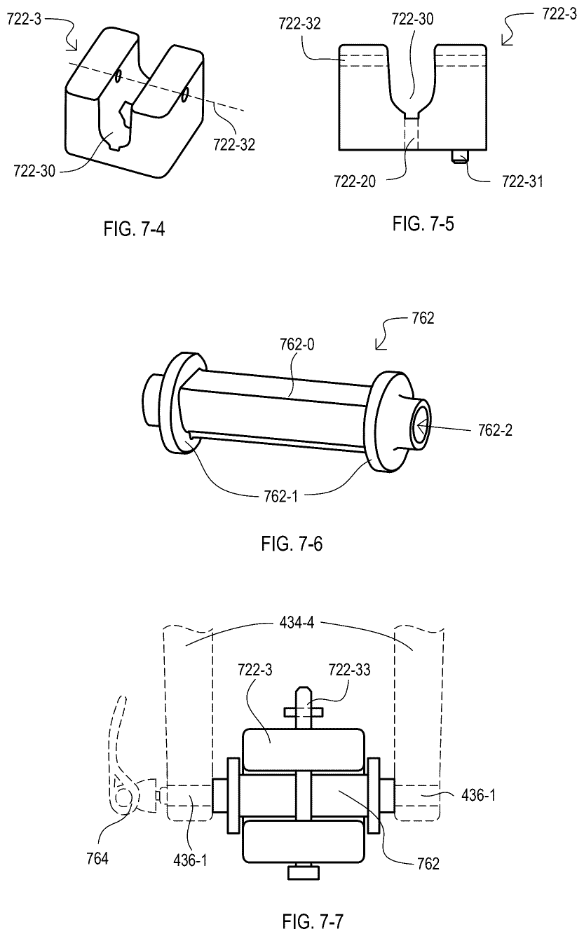

Referring to FIG. 7-0, a perspective view shows a fork receiver 122 that includes a securing frame 722-0, a first moveable member 722-1, second moveable member 722-2, a rotating member 722-3, and securing member 722-4. A securing frame 722-0 can attach to a bottom surface of bottom enclosure, in any suitable fashion. A first moveable member 722-1 can provide movement in a first direction (e.g., a first degree of movement freedom), a second moveable member 722-2 can provide movement in second direction, different from a first direction (e.g., a second degree of movement freedom). A rotating member 722-3 can provide rotational movement. A securing member 722-4 can secure rotating member 722-3 to second moveable member 722-2, and in some embodiments, secure rotating member 722-3 in a desired rotational position.

FIG. 7-1 is a top view showing a securing frame 722-0 with a first moveable member 722-1 disposed therein. A first moveable member 722-1 can have a first degree of movement freedom 756, which can be generally toward a front side and back side. In the embodiment shown, a first moveable member 722-1 can slide below an overlapping lip portion of a securing frame 722-0. However, such an arrangement should not be construed as limiting. Embodiments can include any other sliding arrangement, including but not limited to rails, bearings, grooves to name but a few.

FIG. 7-2 is a top view showing a first moveable member 722-1 with a second moveable member 722-2 disposed therein. A second moveable member 722-2 can have a second degree of movement freedom 758, which can be generally different from the first direction 756 (shown in FIG. 7-1). In the embodiment shown, a second moveable member 722-2 can slide below an overlapping lip portion of a first moveable member 722-1. However, as in the case of FIG. 7-1, such an arrangement should not be construed as limiting. In the embodiment shown, a second moveable member 722-2 can also include rotation/securing hole 722-20 and guiding channel 722-21. A rotation/secure hole 722-20 can enable a rotating member 722-3 to rotate with respect to first moveable member 722-2 and be secured thereto. A guiding channel 722-21 can be provided to limit a rotational movement of rotating member 722-3.

FIG. 7-3 is a top view showing a rotating member 722-3 positioned above, and connected to, a second moveable member 722-2. A rotating member 722-3 can have a third second degree of movement freedom 760, which can be rotational movement. In the embodiment shown, rotating member 722-3 can rotate about a securing structure within rotation/securing hole 722-20. A rotating member 722-3 can include an opening 722-30 which, as is described herein, can receive a front axle substitute.

FIGS. 7-4 and 7-5 are a perspective and side cross sectional view of a rotating member 722-3 according to an embodiment. A rotating member 722-3 can include an opening 722-30 and secure through holes 722-32 that extend through rotating member 722-3 above opening 722-30. Rotation/securing hole 722-20 can extend through rotating member 722-3 at a bottom of opening 722-30, and can receive a securing member 722-4 (shown in FIG. 7-0). A guide pin 722-31 can extend from a bottom surface of rotating member 722-3 for insertion into a guiding channel 722-21 of second moveable member 722-2.

FIG. 7-6 shows a front axle substitute 762 that can be included in a fork receiver 122. A front axle substitute 762 can be positioned within an opening 722-30 of a rotating member 722-3, and can receive front dropouts of a bicycle frame. In the embodiment shown, a front axle substitute 762 can include a seating portion 762-0, securing members 762-1, and securing through hole 762-2. Seating portion 762-0 can be positioned within an opening 722-30 of rotating member 722-3. Securing members 762-1 can ensure front axle substitute 762 remains in position within rotating member 722-3. In some embodiments, securing members 762-1 can be adjustable in a lateral direction. A securing through hole 762-2 can extend through a front axle substitute 762. In some embodiments, securing through hole 762-2 can receive a quick release mechanism. In some embodiments, such a quick release mechanism can be the same as that which secures a front wheel to the transported bicycle frame.

FIG. 7-7 is a top view showing a rotating member 722-3 with a front axle substitute 762 positioned in its opening. Also shown is a bike assembly secured to rotating member 722-3 at bike frame front forks 434-4. It is understood that front dropouts 436-1 can connect at ends of front axle substitute 762. FIG. 7-7 also shows a securing pin 722-33 that can extend through secure through holes 722-32 to maintain front axle substitute 762 within the opening of rotating member 722-3. Also shown is a quick release mechanism 764 that can extend through front dropouts 436-1 and front axle substitute 762 and thus secure a bicycle assembly to a rotating member 722-3 (and thus to fork receiver 122).

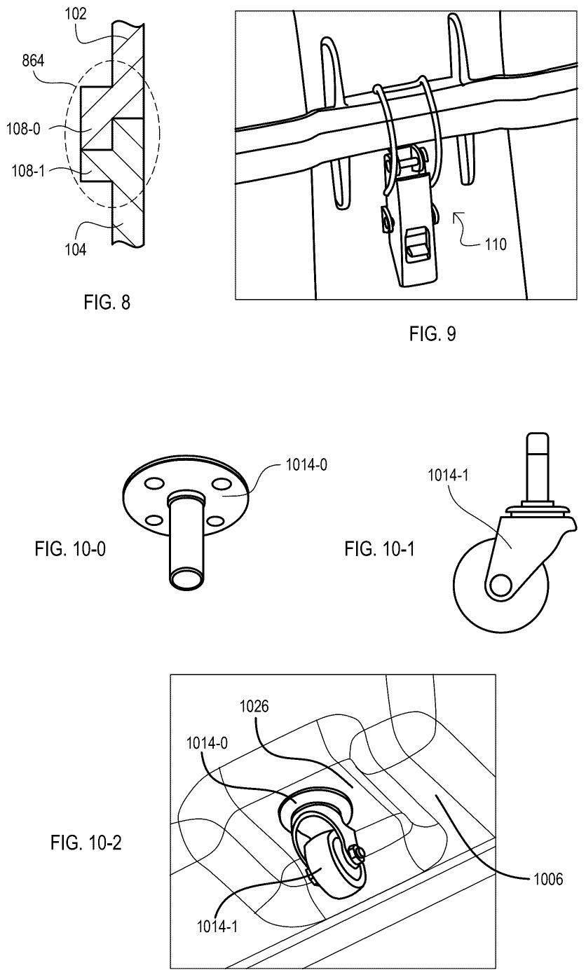

FIG. 8 is a diagram showing a top enclosure 102 and bottom enclosure 104 having edges that can mate with one another. In some embodiments, all or a part of a top enclosure edge 108-0 and all or part of a bottom of enclosure edge 108-1 can have shapes that conforms with one another to form an enclosure mating 864. While FIG. 8 shows one particular shape, such a shape should not be construed as limiting.

FIG. 9 is a diagram showing a fastener 110 that can be included in embodiments. A fastener 110 can be a spring-clamp type fastener. However, as noted herein, embodiments can include any other suitable type of fastener.

FIGS. 10-0, 10-1 and 10-2 are diagrams showing a wheel assembly that can be included in embodiments. FIG. 10-0 shows a caster socket 1014-0 that can be attached to a bottom surface of a carrier. FIG. 10-1 shows a wheel swivel 1014-1 that can be connected to a caster socket 1014-0 to form a caster assembly. FIG. 10-2 shows a caster socket 1014-0 and wheel swivel 1014-1 formed in a wheel recess 1026 formed in a bottom surface 1006.

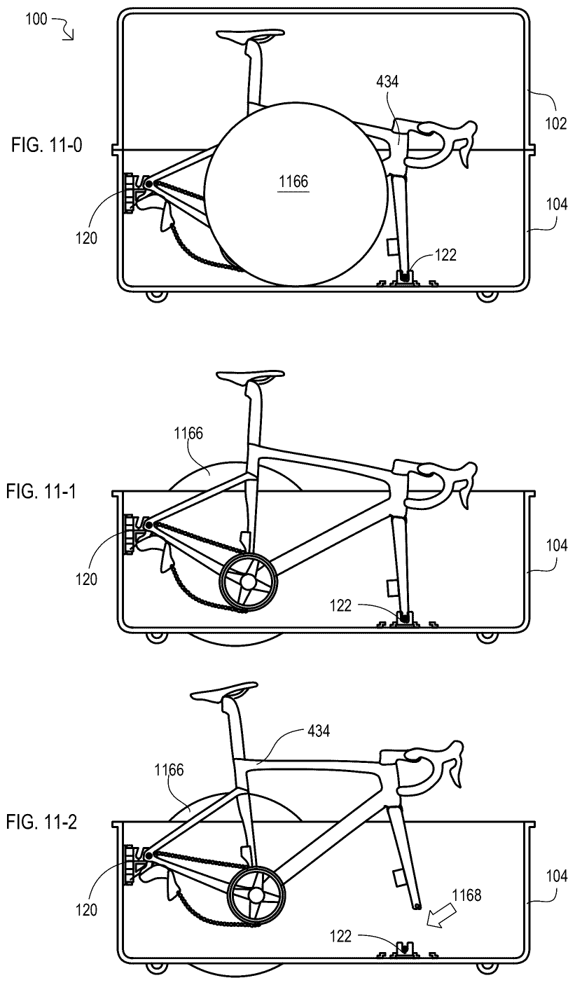

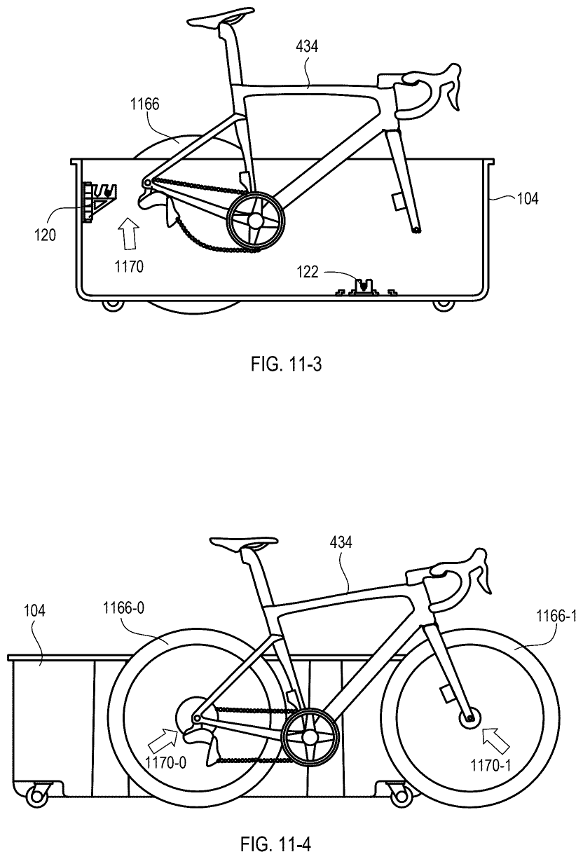

FIGS. 11-0, 11-1, 11-2, 11-3 and 11-4 are side views showing a carrier and method according to an embodiment. FIG. 11-0 shows a bike assembly 434 secured within a carrier 100 within a top enclosure 102 and bottom enclosure 104. In the embodiment shown, wheels 1166 corresponding to the bicycle assembly 434 can also be included within the carrier 100. A bicycle assembly 434 can be connected to a rear frame receiver 120 and fork receiver 122 as described herein, or equivalents. Bicycle assembly 434 and wheels 1166 can be contained in carrier 100, and so not accessible from the outside.

According to embodiments, a bicycle assembly 434 can be substantially assembled. This can include having any or all of handlebars 434-1, forks 434-2, crankset 434-3, driving member 434-4 (e.g., chain and derailleur), seat 434-5, and brake and/or shifting system 434-6 attached thereto, and in working order. In some embodiments, a bicycle assembly may only need to have wheels attached to be in working order.

FIG. 11-1 shows the release of fasteners (not shown) and the removal of the top enclosure, resulting in secured bike assembly 434 being accessible. Wheels 1166 have been removed and positioned close by.

FIG. 11-2 shows a releasing 1168 of bicycle assembly 434 from a fork receiver 122. In some embodiments, such an action can include operating a quick release mechanism.

FIG. 11-3 shows a releasing 1170 of bicycle assembly 434 from a rear frame receiver 122. In some embodiments, such an action can include operating a quick release mechanism.

FIG. 11-4 shows a bicycle assembly 434 after connection 1170-0 of a rear wheel 1166-0 and connection 1170-1 of a front wheel 1166-1. As noted above, in some embodiments, a bicycle assembly 434 may only need the attachment of wheels 1166-0/1 to be in substantially working order. Further, in some embodiments, the same quick release mechanisms used to secure a bicycle frame 434 to rear frame receiver 120 and fork receiver 122 can be used in to connect 1170-0/1 wheels to bicycle frame 434.

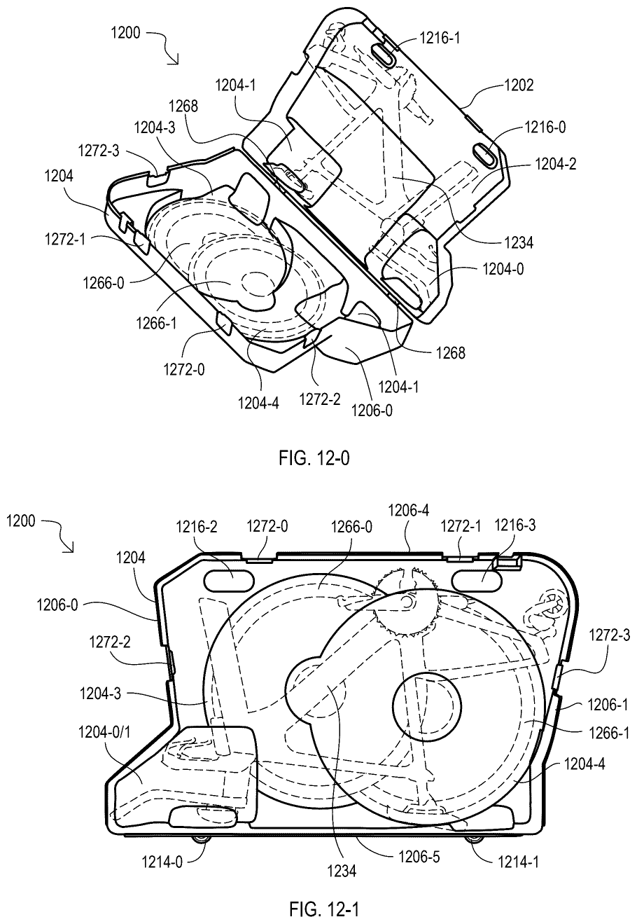

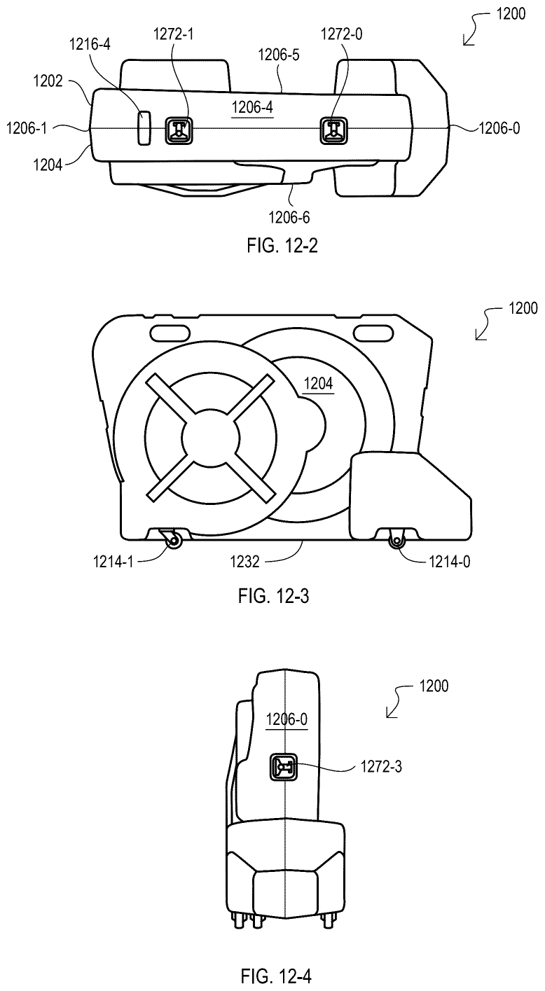

FIGS. 12-0, 12-1, 12-2, 12-3 and 12-4 are diagrams showing a bicycle carrier 1200 according to an embodiment. Referring to FIG. 12-0, a carrier 1200 can store a bicycle assembly 1234 and wheels 1266-0/1. A bicycle assembly 1234 can be substantially assembled, enabling the bicycle to be quickly and easily assembled once it has arrived at a destination. In some embodiments, a bicycle can essentially have only its wheels removed prior to be stowed in the carrier 1200. FIG. 12-0 shows a bicycle carrier 1200 in an open configuration. A carrier 1200 can include a first enclosure 1202 and a second enclosure side 1204 connected by a hinge assembly 1268. First and second enclosures 1202/1204 can swing along hinge assembly 1268 to close and open the carrier 1200.

A first enclosure 1202 can include a bicycle assembly recess 1270 shaped to receive a bicycle assembly 1234, which can take any of various forms, including a road type bicycle, mountain type bicycle or triathlon bicycle, as but a few examples. As in the case of other embodiments, a bicycle assembly 1234 can have a frame with any or all of various components connected thereto, in working order. Such components can include, but are not limited to, forks, handlebars, a crankset, driving members, seat, brake system and/or shifting system.

In some embodiments, a first enclosure 1202 can include any of a first handlebar recess 1204-0, a seat recess 1204-1, and/or a fork recess 1204-2. A first handlebar recess 1204-0 can receive handlebars that are assembled to a frame. A seat recess 1204-1 can receive a seat that is assembled to a frame. Fork recess 1204-2 can receive forks that are assembled to a frame.

A second enclosure side 1204 can include a first wheel recess 1204-3 and a second wheel recess 1204-4. A first wheel recess 1204-3 can receive a first wheel 1266-0 and a second wheel recess 1204-4 can receive a second wheel 1266-1. In some embodiments, first wheel recess 1204-3 can be deeper than second wheel recess 1204-4. In some embodiments, a second wheel recess 1204-4 can be offset from first wheel recess 1204-3 such that a second wheel 1266-1 can overlap a first wheel 1266-0 when the wheels 1266-0/1 are stowed. In some embodiments, a second enclosure 1204 can include a second handlebar recess 1204-1 that can receive handlebars assembled to a frame.

According to embodiments, a carrier 1200 can include external handles. In the embodiment shown, handles 1216-0/1 can be formed by recesses in an outer surface of the carrier 1200. However, other embodiments can include any other suitable handles.

According to embodiments, a carrier 1200 can include latches for securing the carrier in a closed configuration. In the embodiment shown, a carrier 1200 can include latches 1272-0/1 formed on a top surface, and a latch 1272-2 formed on a front 1206-0 and latch 1272-3 formed on an opposing back. However, other embodiments can include any other suitable mechanisms for securing a carrier in a closed configuration.

In some embodiments, to store a bicycle, bicycle wheels 1266-0/1 can be detached from the frame assembly, stored in second enclosure 1204. In some embodiments, in addition to wheels 1266-0/1, pedals can also be removed and a resulting bicycle assembly 1234 can be stored in a first enclosure side 1202. A bicycle can thus retain is configuration while being transported. Along these same lines, once a carrier 1200 has arrived at a destination, wheels 1266-0/1 can be attached to a bicycle assembly 1234, and a bicycle can be essentially ready to ride. That is, minimal assembly and disassembly is needed when transporting a bicycle using carrier 1200.

FIG. 12-1 is a side cross sectional view of the carrier shown in FIG. 12-0, with the carrier 1200 being in a closed configuration. Like items are identified with the same reference characters. FIG. 12-1 shows how, when in a closed configuration, a bicycle assembly 1234 can be situated adjacent to wheels 1266-0/1. Further, in a closed configuration, first and second handlebar recesses 1204-0/1 can be adjacent to one another, forming a contiguous space for handlebars.

FIG. 12-1 further shows how, in a closed configuration, a carrier 1200 can include a bottom surface 1206-5, a top surface 1206-4, a front side 1206-0 and a back side 1206-1.

In some embodiments, a carrier 1200 can include mechanisms for rolling the carrier on a flat surface. In the embodiment shown, a carrier 1200 can include casters (two of four shown as 1214-0/1) attached to a bottom surface 1206-5.

FIGS. 12-2, 12-3 and 12-4 are various views of a carrier 1200, like that of FIGS. 12-0 and 12-1 in a closed configuration. FIGS. 12-2 to 12-4 refer to like items with the same reference characters.

FIG. 12-2 is a top view of a carrier 1200, and shows a top surface 1206-4, first side 1206-2 and second side surface 1206-3 that can be formed when first and second enclosures 1202/1204 are brought together in a closed position. In the embodiment shown, latches 1272-0/1 can be formed in a top surface 1206-4 to secure a carrier 1200 in a closed configuration. A top surface 1206-4 can also include a recessed handle 1216-4. An outer surface of first enclosure 1202 can include an assembly side surface 1206-5. An outer surface of a second enclosure 1204 can include a wheel side surface 1206-6.

FIG. 12-3 is a wheel side view of a carrier 1200. FIG. 12-3 shows both latches (not shown) can be recessed into an outer surface of a carrier. Casters 1214-0/1 can be recessed into a bottom surface 1232 of a carrier 100. In some embodiments, caster wheels can be removable. In other embodiments, a carrier 1200 can include wheels attached to a bottom surface that are foldable into a bottom surface.

FIG. 12-4 is a first (e.g., front) side view of a carrier 1200. FIG. 12-4 shows how a latch 1272-2 can be formed in a first surface 1206-0 to help secure a carrier 1200 in a closed configuration.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A device, comprising:
a bottom enclosure including a bottom surface, a first bottom side, a second bottom side opposite the first bottom side, a bottom front, and a bottom back opposite the bottom front;
a frame receiver attached to the bottom back and configured to connect to a bicycle frame of a bicycle assembly at rear dropouts at one of a plurality of different distances from the bottom back;
a fork receiver attached to the bottom surface and configured to connect to the bicycle assembly at front fork dropouts, the fork receiver having at least a first degree of freedom in movement and rotational movement;
a plurality of wheels attached to an outer surface of the bottom surface;
a top enclosure including a top surface, a first top side, a second top side opposite the first top side, a top front, and a top back opposite the top front; and
a plurality of fasteners configured to mechanically secure the top enclosure to the bottom enclosure; wherein
when secured together, the bottom and top enclosures form an enclosure volume configured to contain the bicycle assembly in an upright orientation with respect to bottom surface, the bicycle assembly including at least the bike frame with handlebars, crankset, crank arms, and the front forks attached thereto.

2. The device of claim 1, wherein:
when secured together, the bottom and top enclosures form a generally rectangular prism shape, with
the bottom and top fronts forming a carrier front side,
the bottom and top backs forming a carrier back side,
the first top and bottom sides forming a carrier first side that extends between the carrier front and back sides, and
the second top and bottom sides forming a carrier second side that extends between the carrier front and back sides opposite the carrier first side.

3. The device of claim 1, wherein:
when secured together, the bottom and top enclosures completely enclose the bicycle assembly.

4. The device of claim 1, wherein:
the frame receiver includes rotational movement.

5. The device of claim 1, wherein:
the frame receiver includes
a plurality of frame receiver opening disposed at different distances from the bottom back, and
at least one rear axle substitute member configured to be disposed in one of the frame receiver openings and configured to connect at the rear dropouts.

6. The device of claim 5, wherein:
the at least one rear axle substitute member includes a hole therethrough, configured to receive wheel quick release device.

7. The device of claim 1, wherein:
the fork receiver further includes at least a second degree of freedom in movement in a direction different than the first degree of freedom.

8. The device of claim 1, wherein:
the fork receiver first degree of freedom and rotational movement are in planes generally parallel to the bottom.

9. The device of claim 1, wherein:
the fork receiver includes
at least one fork receiver opening, and
at least one front axle substitute member configured to be disposed in the fork receiver opening can connect to front fork dropouts.

10. The device of claim 9, wherein:
the at least one front axle substitute member includes a hole therethrough configured to receive a wheel quick release device.

11. A method, comprising:
removing a top enclosure of a bicycle carrier from a bottom enclosure of the bicycle carrier to enable access to at least a bike assembly secured to the bottom enclosure, the bicycle assembly including at least a bicycle frame with front forks, crankset and handle bars attached thereto;
disconnecting the bike assembly at front fork dropouts from a fork receiver disposed on a bottom surface of the bottom enclosure;
disconnecting the bike assembly at rear dropouts from a rear frame receiver attached to a back of the bottom enclosure; wherein
the rear frame receiver is configured to connect to the rear dropouts at one of a plurality of different distances from the back of the bottom enclosure;
the fork receiver has at least a first degree of freedom of movement and rotational movement; and
when secured together, the bottom and enclosures form the carrier with an enclosed volume configured to contain the bicycle assembly in an upright orientation with respect to a bottom surface of the bottom enclosure.

12. The method of claim 11, wherein:
disconnecting the bike assembly at front fork dropouts and rear dropouts are the only actions necessary to free the bicycle assembly from the bottom enclosure.

13. The method of claim 11, wherein:
the bicycle assembly further includes a working derailleur assembly attached to the bicycle frame.

14. The method of claim 11, wherein:
the bicycle assembly further includes a working brake system.

15. The method of claim 11, wherein:
removing the top enclosure enables access to at least two bicycle wheels stowed within the bottom enclosure.

16. The method of claim 11, wherein:
disconnecting the bike assembly from the fork receiver includes releasing a wheel quick release mechanism.

17. The method of claim 11, wherein:
disconnecting the bike assembly at the rear frame receiver includes releasing a wheel quick release mechanism.

18. The method of claim 11, further including:
prior to removing the top enclosure,
the bottom and top enclosures form a generally rectangular prism shape, with
fronts of the bottom and top enclosure forming a carrier front side,
backs of the bottom and top enclosures forming a carrier back side,
first sides of the top and bottom enclosures forming a carrier first side that extends between the carrier front and back sides, and
second sides of the top and bottom enclosures forming a carrier second side that extends between the carrier front and back sides.

19. The method of claim 11, wherein:
the bicycle assembly further includes an operating shifting system and brake system attached thereto.

20. The method of claim 11, further including:
after removing the top enclosure, removing at least two bicycle wheels from the bottom enclosure.
